(19) United States
(12) Patent Application Publication
(10) Pub. No.: US 2016/0264121 A1
(43) Pub. Date: Sep. 15, 2016

(54) Inflatable Vehicle Incorporating an Air Cushion

(71) Applicants: Mauricio Ricardo DEZEN, Kitchener (CA); Qing HAN, Coquitlam (CA)

(72) Inventors: Mauricio Ricardo DEZEN, Kitchener (CA); Qing HAN, Coquitlam (CA)

(21) Appl. No.: 15/061,302

(22) Filed: Mar. 4, 2016

Related U.S. Application Data
(60) Provisional application No. 62/130,239, filed on Mar. 9, 2015.

(51) Int. Cl. B60V 1/15; B60V 1/16; B60V 1/04

(52) U.S. Cl. CPC B60V 1/15; B60V 1/043; B60V 1/16

(57) ABSTRACT

An inflatable vehicle incorporating an air cushion is provided. The inflatable vehicle includes a main body defining therein a cavity and configured to be inflated. The vehicle also includes an inflatable, flexible skirt positioned below the main body, the skirt defining therein another cavity and including apertures to allow air to escape. The vehicle also includes a blower configured to blow air, the blower being supported by the main body when inflated. The vehicle also includes a duct system configured to be in fluidic communication with the blower, the cavity of the main body and the cavity of the skirt. The duct system includes valves to control the flow of air from the blower to inflate the main body and subsequently inflate the skirt to form the air cushion.

### CROSS-REFERENCE TO RELATED APPLICATIONS

This application claims priority to U.S. Provisional Patent Application No. 62/130,239 filed on Mar. 9, 2015, entitled “Inflatable Vehicle Incorporating an Air Cushion” and the entire contents of which is incorporated herein by reference.

### TECHNICAL FIELD

The following invention or inventions generally relates to a transportation device of the air cushion type.

### DESCRIPTION OF THE RELATED ART

The usefulness of air cushion vehicles (ACVs) is well known. ACVs work on the principle of having a plenum chamber bounded by a flexible skirt. The plenum chamber, for example, is a contained volume of fluid (air, in most cases) at a positive pressure, which effectively creates an air cushion for the vehicle to ride on. An ACV may not actually be in contact with the ground. An ACV is able to traverse various terrains and overcome small obstacles with ease. Due to their versatility, ACVs have been used in a variety of applications ranging from military and commercial transport to maritime rescue and even personal recreation. ACVs conventionally have rigid operating platforms to support both the operators and the air supply means.

### SUMMARY

Non-limiting example embodiments of an inflatable vehicle are provided, including example features and aspects of an inflatable vehicle.

In an example embodiment, an inflatable vehicle incorporating an air cushion is provided. The inflatable vehicle includes: a main body defining therein a cavity and configured to be inflated; an inflatable, flexible skirt positioned below the main body, the skirt defining therein another cavity and comprising apertures to allow air to escape; a blower configured to blow air, the blower supported by the main body when inflated; and a duct system configured to be in fluidic communication with the blower, the cavity of the main body and the cavity of the skirt, and the duct system comprising valves to control the flow of air from the blower to first inflate the main body and subsequently inflate the skirt to form the air cushion.

In an aspect, the inflatable vehicle further includes a propulsion system that ejects air to provide a propulsive force. In another aspect, the propulsion system includes a conduit supported by the main body when inflated, the conduit is fluidic communication with the blower via the duct system and configured to eject air to provide the propulsive force. In another aspect, the conduit ejects air towards a rear of the inflatable vehicle. In another aspect, the propulsion system further includes a second conduit in fluidic communication with the blower and is positioned to eject air towards a front facing direction of the inflatable vehicle to provide another propulsive force. In another aspect, the propulsion system includes at least one other blower.

In another aspect, the inflatable vehicle includes a steering assembly, which includes a steering column and handlebars, the steering assembly supported by the main body when inflated. In another aspect, the steering column can be retracted to a smaller size. In another aspect, one or more wheels are positioned adjacent to or are positioned on the steering column. In another aspect, the inflatable vehicle is configured to be deflated and stored into a holder attached to the steering column, and wherein the holder is transportable by pushing or pulling the steering column to roll the one or more wheels. In another aspect, the holder is a bag. In another aspect, the inflatable vehicle is configured to be deflated and stored into a holder in a backpack form, the holder attached to the steering column that is in a retracted state.

In another aspect, the skirt is attached to a perimeter of the main body and is also attached to a center portion of a bottom surface of the main body.

In another aspect, the skirt is substantially torus-shaped when inflated.

In another aspect, at least a portion of the blower is positioned within the cavity of the main body.

In another aspect, the blower is configured to intake ambient air through a grill located on a top surface of the main body, and to output the ambient air under pressure into the duct system.

In another aspect, the valves comprise a valve to control the flow of air into the cavity of the main body and a valve to control the flow of air into the cavity of the skirt.

In another aspect, the inflatable vehicle further includes a conduit in fluidic communication with the blower via the duct system and configured to eject air to provide a propulsion force, and the valves include a valve to control the flow of air into the cavity of the main body, a valve to control the flow of air into the cavity of the skirt, and a valve to control the flow of air into the conduit.

In another aspect, the skirt forms a tubular structure when inflated and at least one the apertures is positioned on an inner surface of the tubular structure. In another aspect the tubular structure is continuous and defines an enclosed space.

In another aspect, the inflatable vehicle further comprises controls for vehicle inflation, vehicle speed and steering. In another aspect, a remote control device is used to control one or more of the vehicle inflation, the vehicle speed and the steering.

In another aspect, a plurality of attachment points are provided on the top surface of the main body to facilitate the affixation of accessories to the vehicle.

In another example, a control system is provided for an inflatable vehicle incorporating an air cushion. The control system includes: a blower in fluidic communication with a cavity defined by an inflatable main body and a cavity defined by an inflatable skirt positioned below the main body; valves to control the flow of air between the blower and the cavity of the main body, and between the blower and the cavity of the skirt; a processor configured to control the blower and the valves; and memory including instructions executable by the processor. The instructions include controlling the blower and the valves to first inflate the main body to form a substantially rigid structure that supports the blower and to subsequently inflate the skirt to form the air cushion.

In an aspect, the control system further includes a steering actuator and the instructions further include receiving one or more steering inputs and controlling the steering actuator based on the one or more steering inputs.

### BRIEF DESCRIPTION OF THE DRAWINGS

Embodiments of the invention or inventions are described, by way of example only, with reference to the appended drawings wherein:

FIG. 1 is an illustration of an example embodiment of an inflatable vehicle incorporating an air cushion, which is in a fully inflated state.

FIG. 2 is a top view of the embodiment of FIG. 1.

FIG. 3 is a bottom view of the embodiment of FIG. 1.

FIG. 4 is a side view of the embodiment of FIG. 1.

FIG. 5 is a front view of the embodiment of FIG. 1.

FIG. 6 is a cross-sectional side view of the embodiment of FIG. 1, the cross-section taken along line A-A shown in FIG. 2.

FIG. 7 is an illustration of the embodiment of the vehicle of FIG. 1 in a deflated state.

FIG. 8 is a front view of an example embodiment of an inflatable vehicle incorporating an air cushion, which is deflated and is in a trolley bag form.

FIG. 9 is a side view of the embodiment of FIG. 8.

FIG. 10 is a perspective view of the embodiment of FIG. 8.

FIG. 11 is a front view of an example embodiment of an inflatable vehicle incorporating an air cushion, which is deflated and is in a backpack form.

FIG. 12 is a side view of the embodiment of FIG. 11.

FIG. 13 is a perspective view of the embodiment of FIG. 11.

FIG. 14 is a perspective view of another example embodiment of an inflatable vehicle incorporating an air cushion, which is in a fully inflated state.

FIG. 15 is a perspective view of another example embodiment of an inflatable vehicle incorporating an air cushion, with an exterior surface partially cut away to show internal members.

FIG. 16 is a top view of the embodiment shown in FIG. 16.

FIG. 17 is a perspective view of the vehicle shown in FIG. 14, but with a peripheral dust curtain attached.

FIG. 18 is a top view of the embodiment of FIG. 17.

FIG. 19 is a bottom view of the embodiment of FIG. 17.

FIG. 20 is a side view of the embodiment of FIG. 17.

FIG. 21 is a front view of the embodiment of FIG. 17.

FIG. 22 is a cross-sectional side view of the embodiment of FIG. 17, the cross-section taken along line B-B in FIG. 18.

FIG. 23 is an illustration of the embodiment of FIG. 17, with the vehicle in a deflated state.

FIG. 24 is a front view of another example embodiment of an inflatable vehicle incorporating an air cushion, which is deflated and is in a trolley bag form.

FIG. 25 is a side view of the embodiment of FIG. 24.

FIG. 26 is a perspective view of the embodiment of FIG. 24.

FIG. 27 is a front view of another example embodiment of an inflatable vehicle incorporating an air cushion, which is deflated and is in a backpack form.

FIG. 28 is a side view of the embodiment of FIG. 27.

FIG. 29 is a perspective view of the embodiment of FIG. 27.

FIG. 30 is a cross-sectional side view of an example embodiment of an inflatable vehicle incorporating an air cushion, which shows all air chambers are deflated.

FIG. 31 is an illustration of the vehicle in FIG. 30 but the inflatable cavity of the main body is inflated.

FIG. 32 is an illustration of the vehicle in FIG. 31, but the main body is inflated and the inflatable, flexible skirt is pressurized and creates an air cushion.

FIG. 33 is an illustration of the vehicle in FIG. 32, but the main body is inflated, the skirt is pressurized, and the rear facing conduit is open.

FIG. 34 is an illustration of the vehicle in FIG. 32, but the main body is inflated, the skirt is pressurized, and the forward facing conduit is open.

FIG. 35 is an illustration of an inflatable vehicle incorporating an air cushion, and further includes a chair attachment.

FIG. 36 is an illustration of an inflatable vehicle incorporating an air cushion, and further includes a platform attachment.

FIG. 37 is an illustration of an inflatable vehicle incorporating an air cushion, and further includes a horse toy attachment.

FIG. 38 shows different stages of transforming an inflatable vehicle incorporating an air cushion, from a backpack form to an inflated and operable vehicle form.

FIG. 39 is a system diagram showing components of an inflatable vehicle incorporating an air cushion.

FIG. 40 is a flow chart of example processor executable instructions for inflation, hovering, forward motion and braking/reverse motion.

FIG. 41 is a flow chart of example processor executable instructions for activating cruise control.

FIG. 42 is a flow chart of example processor executable instructions for vehicle deflation.

FIG. 43 is a perspective view of another example embodiment of an inflatable vehicle incorporating an air cushion, which is in a fully inflated state.

FIG. 44 is a bottom view of the embodiment of FIG. 43.

FIG. 45 is a bottom perspective view of the embodiment of FIG. 43.

FIG. 46 shows an automated folding progression of an inflatable vehicle incorporating an air cushion.

### DETAILED DESCRIPTION

It will be appreciated that for simplicity and clarity of illustration, in some cases, reference numerals may be repeated among the figures to indicate corresponding or analogous elements. In addition, some details or features are set forth to provide a thorough understanding of the embodiments described herein. However, it will be understood by those of ordinary skill in the art that the embodiments described herein are illustrative examples that may be practiced without these details or features. In other instances, well-known methods, procedures and components have not been described in detail so as not to obscure the invention illustrated in the examples described herein. Also, the description is not to be considered as limiting the scope of the example embodiments described herein or illustrated in the drawings.

Although air cushion vehicles (ACVs) are often heralded for their versatility, they also suffer from drawbacks. ACVs are sometimes also called hovercraft. Though they have the ability to traverse a multitude of terrains and overcome small obstacles with ease, existing ACVs include rigid platforms to support the operator(s), the engines, the power source and the air movers. Existing ACVs are usually large. That is to say the floor space taken up by the vehicle is significantly larger than the floor space of the operator(s).

Some ACVs are geared towards personal transportation, but these ACVs still usually use a large space and necessitate appropriate storage and moving facilities.

ACVs generally are difficult to transport and store when not in use. For example, a large crate may be required to store or transport, or both, an ACV. Furthermore, some ACVs are shipped as components to reduce space and require assembly to form an operable ACV.

It is herein recognized that it is desirable to easily transport an ACV when not in use and to easily store the ACV when not in use. Furthermore, it is desirable to quickly pack and unpack an ACV. Therefore, the ACV can be quickly and conveniently used even when previously stored, and can be quickly put into storage or transport.

The proposed transportation vehicle described herein addresses the aforementioned difficulties by providing an air cushion vehicle with an inflatable main body. In particular, by implementing the air cushion technology, the vehicle will not be in constant rigid contact with the surface upon which it is moving, thus receiving the benefits of all-terrain travel and the ability overcome small obstacles and uneven topography. By constructing the main body of the vehicle using an inflatable structure, the form factor of the vehicle is greatly reduced after being deflated. This allows for convenient transport of the vehicle when not in use. The vehicle may be transformed to a smaller form, such as a trolley bag or backpack. Other smaller forms are applicable.

In an example embodiment, an inflatable vehicle incorporating an air cushion is provided. The inflatable vehicle includes a main body defining therein a cavity and configured to be inflated. The vehicle also includes an inflatable, flexible skirt positioned below the main body, the skirt defining therein another cavity and comprising apertures to allow air to escape. The vehicle also includes a blower configured to blow air, the blower being supported by the main body when inflated. The vehicle also includes a duct system configured to be in fluidic communication with the blower, the cavity of the main body and the cavity of the skirt. The duct system includes valves to control the flow of air from the blower to inflate the main body and subsequently inflate the skirt to form the air cushion.

In another example embodiment, a control system is provided for an inflatable vehicle incorporating an air cushion. The control system includes a blower in fluidic communication with a cavity defined by an inflatable main body and a cavity defined by an inflatable skirt positioned below the main body. The control system also includes valves to control the flow of air between the blower and the cavity of the main body, and between the blower and the cavity of the skirt. The control system further includes a processor configured to control the blower and the valves, and memory comprising instructions executable by the processor. The instructions include controlling the blower and the valves to first inflate the main body to form a substantially rigid structure that supports the blower and to subsequently inflate the skirt to form the air cushion.

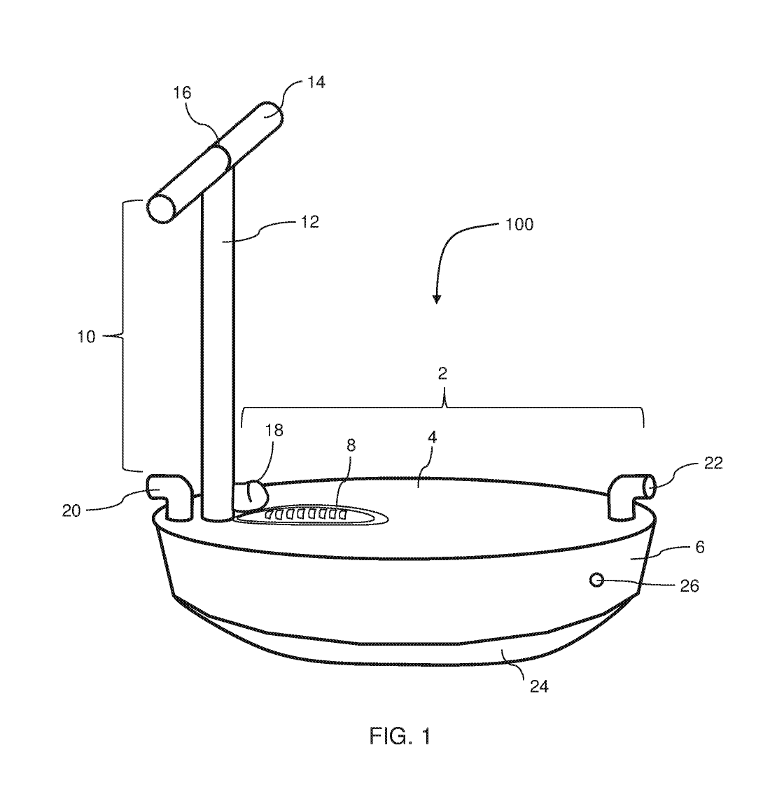

FIG. 1 shows a perspective view of an example embodiment 100 of an inflatable ACV. The ACV includes an inflatable main body 2 which is preferably made of a durable, light-weight, air-tight material such as KEVLAR, drop stitch or soft glass fiber sheet. Other materials that allow for inflation and deflation may be used to make the main body. Although not pictured in FIG. 1, the top surface of the main body 4 is substantially covered with a non-slip material so as to facilitate better traction for an operator standing thereon. Examples of non-slip material include rubber and high friction plastics. Furthermore, the main body 2 includes a side surface 6 upon which there is access to a valve or re-closable aperture 26 to allow for manual inflation or deflation of the main body 2.

In the example embodiment in which the man body 2 is made of a drop stitch, the main body includes at least two pieces of polyester woven support fabric (e.g. a top piece and a bottom piece) that are joined with hundreds or thousands of fine polyester thread lengths. One end of a given thread is connected to one piece and the other end of the given thread is connected to the other piece. For example, this base material is made in strips from five to ten feet in width, and up to 400 needle heads may be used in the setup. Each needle sews a continuous, evenly spaced thread, back and forth between the two pieces of woven fabric, locking them together into a strong unit. An air-tight coating is applied to the outer surfaces of both sides of the material. The sidewall material is made of polyester base fabric that is coated on both sides. Polyester thread is used throughout because it is strong, durable and has little stretch. The sidewall material of the main body is joined to the top and bottom pieces of the drop-stitch material, for example by gluing or other means. A wide seam tape is glued over each lap seam to produce an air-tight main body. In an example embodiment, the main body is inflated to pressures up to 15 pounds per square inch.

Other constructions and materials that include threads or string like material extending between a top piece of material and a bottom piece of material may be used for the drop-stitch construction of the main body.

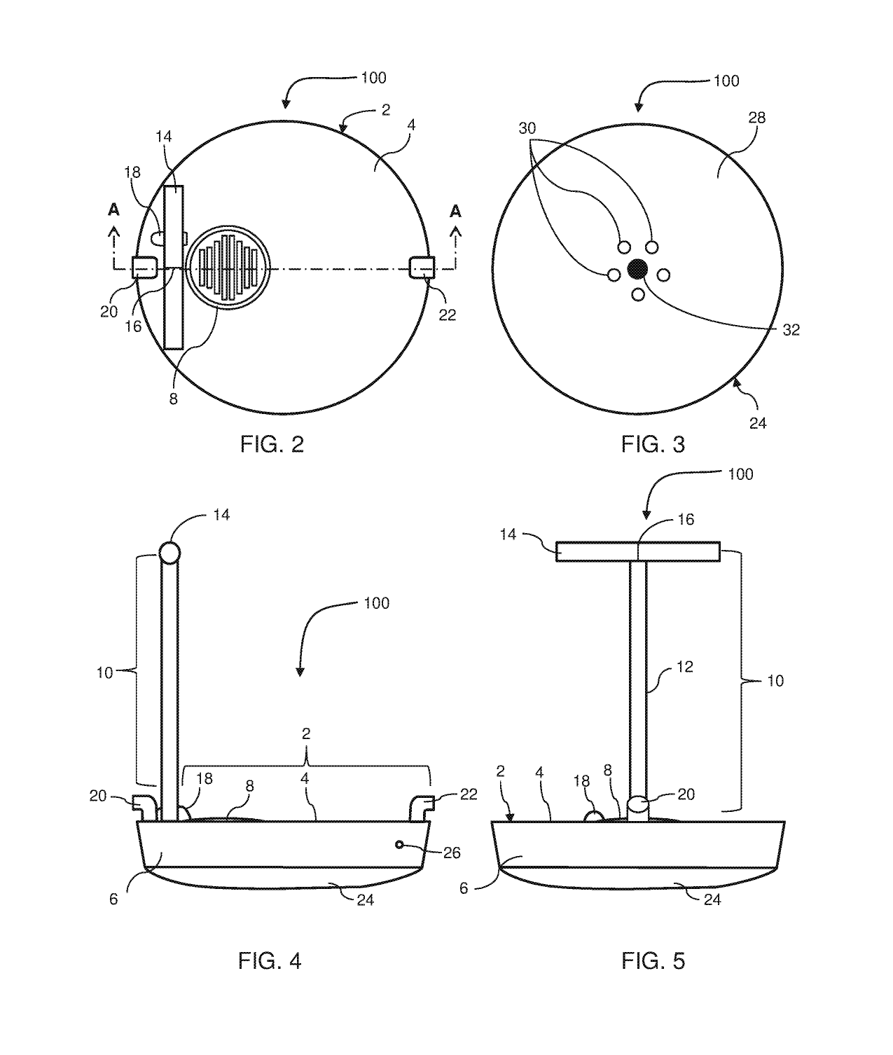

FIGS. 2, 3, 4 and 5 show orthographic views of the vehicle 100, namely they represent top, bottom, side and front views, respectively. FIG. 2 shows a top view of the vehicle 100, and in particular it shows the main body 2 having a substantially circular profile. It should be noted that although the various embodiments of the vehicle show the main body 2 as having a substantially circular profile, the vehicle is not limited to this shape. For example, other top view profiles include oval, square, rectangular, hexagonal, octagonal and irregular shapes.

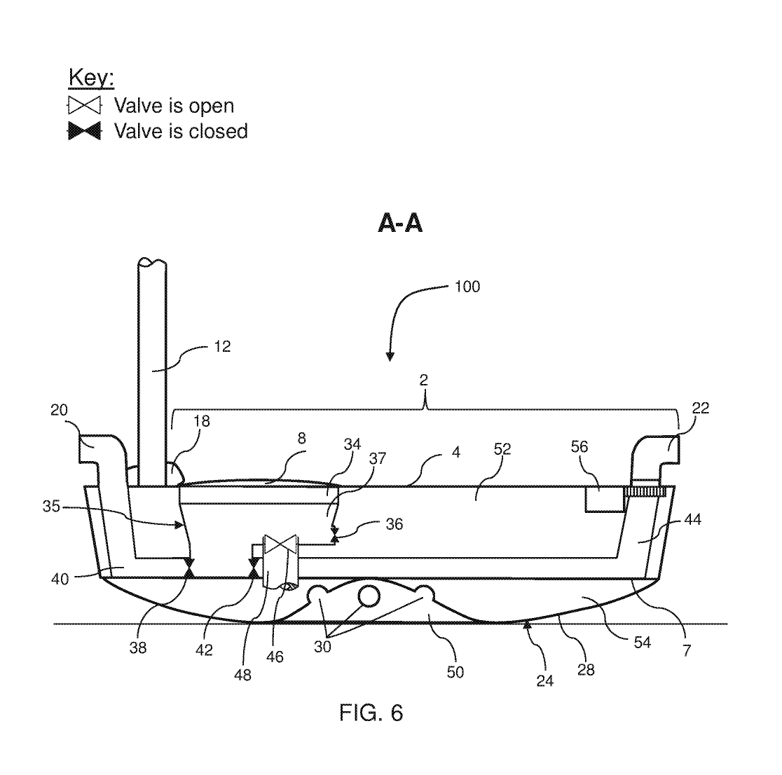

The vehicle 100 also includes an inflatable, flexible torus-shaped skirt 24. As shown in FIG. 1, the skirt 24 is preferably attached to the perimeter of the bottom surface of the main body 7 and, as shown in FIG. 3, the bottom surface of the skirt 28 has substantially the same profile as the main body 2. As mentioned, the main body 2 is not limited to the circular profile shown in the various embodiments, thus likewise the bottom surface of the skirt 28 is not limited to having a circular profile either. In the example embodiments shown, the skirt 24 is also attached to a center portion 32 of the bottom surface of the main body 7. Also shown in FIG. 3 is a plurality of apertures 30 positioned in an evenly spaced circular manner in close vicinity to the center portion 32. As shown in FIG. 6, a cross-sectional view of the vehicle 100 taken along the line A-A, due to the attachment points of the skirt 24 and the subsequent formation of the torus shape, the plurality of apertures 30 are in fact positioned on an upwardly curved surface of the interior annulus of the skirt 24. FIG. 6 also shows the air cushion volume 50, being defined by the curved surface of the interior annulus of the skirt 24, the centre portion 32 of the bottom surface of the main body 7, and the surface upon which the vehicle moves. By creating a volume of positive pressure underneath the vehicle, lift is achieved.

The apertures 30 may be positioned in different places on the skirt other than what is shown. Other configurations and positions of apertures that facilitate forming an air cushion may be used for the inflatable vehicle.

The vehicle 100 also includes one or more conduit projections 20 and 22 that expel air to provide propulsion or steering or both. These may also be called propulsion nozzles. These conduits may be positioned on the top surface of the main body 4. For example one conduit projection 20 is front-facing and another conduit projection 22 is rear-facing. Both conduit projections are supported by the main body when inflated and are configured to eject air to provide propulsive forces. These propulsive forces facilitate the horizontal translation of the vehicle. Note that although the various embodiments of the vehicle show only one conduit projection facing the rear of the vehicle, more conduit projections can be included. Furthermore, the positioning of both conduit projections 20 and 22 is not limited to the top surface of the main body 4 and can instead be situated on different parts of the vehicle.

As most clearly shown in FIG. 6, the conduit projection 20 extends from a forward conduit 40 and the conduit projection 22 extends from a rear conduit 44.

The vehicle 100 also includes a blower 34, shown best in FIG. 6, which serves as the air supply means for the vehicle. The blower 34 is configured to intake atmospheric air through a grill 8 located on the top surface of the main body 4, and to output the atmospheric air into a duct system 35. The grill 8 100 aides in obstructing large particulates from being drawn into the blower 34. In an example embodiment, at least a portion of the blower 34 is positioned within the cavity of the main body 52 so as to reduce protrusions on the top surface of the main body 2. However, other positions and configurations where the blower is supported by the inflated main body are applicable to the principles described herein. The blower 34 can be powered using petrol or electrical means. Preferably, the blower 34 will be powered via electrical means and will thus be configured to allow for a rechargeable battery to be removably attached to, as a non-limiting example, the top surface of the main body 4. A solar panel positioned on the vehicle 100 may be used to charge the battery.

The duct system 35, shown in FIG. 6, includes a plurality of valves and is configured to be in fluidic communication with the blower 34. The duct system 35 includes a main duct 37 having a first valve 36. The main duct is in fluidic communication with a forward conduit 40 and a rear conduit 44. The forward conduit 40 has a second valve 38 and the rear conduit 44 has a third valve 42. Furthermore, the main duct 37 of the duct system 35 is in fluidic communication with an air cushion duct 48 containing a fourth valve 46.

The first valve 36 controls the flow of air between the main duct 37 and the cavity of the main body 52. The second valve 38 controls the flow of air between the main duct 37 and the forward conduit 40. The third valve 42 controls the flow of air between the main duct 37 and the rear conduit 44. The fourth valve 46 controls the flow of air between the main duct 37 and the air cushion duct 48 and the cavity of the skirt 54. Other configuration of valves or devices may be used for controlling the flow of air from a blower to the cavity defined by the main body, the cavity defined by the skirt, and one or more propulsion nozzles. In the figures, when a valve is filled white, it represents a valve in an open position. If a valve is instead filled black, it represents a valve in a closed position. In an example embodiment, the valves are electromechanically controlled to open and close.

The vehicle 100 also includes a steering assembly 10. The steering assembly 10 consists of a steering column 12, handlebars 14 and a hinge system 16, and is shown in FIGS. 1, 4, 5 and 7. The steering assembly is supported by the main body 2 when it is inflated. The hinge system allows each handle bar to rotate or pivot downwards to be positioned alongside the steering column. This provides a more compact from factor. There may be a separate hinge for each handle bar. The steering assembly 10 is configured to allow for rotational motion about an axis collinear with the vertical axis of the steering column 12. The steering assembly 10 is further configured to relay information regarding rotational motion to a rear facing conduit projection directional control mechanism 56, shown in FIG. 6, via systems that are mechanical, wired, or wireless or a combination thereof. For example, if the operator rotates the steering assembly 10 in the clockwise direction over a specified angle with respect to a rest position, the directional control mechanism 56 will consequently rotate the rear facing conduit projection 22 in the counter-clockwise direction over a corresponding angle, thus facilitating an intuitive steering experience. The systems used to relay rotational information to the directional control mechanism 56 can include, but are not limited to: a purely belt and gear based system, a wired electromechanical system incorporating a servo motor and a system of gears or, an electromechanical system incorporating a signal generator and a signal receiver to allow wireless communication between the steering assembly 10 and the directional control mechanism 56. For example, in a wireless system, infrared radio signals, or Bluetooth communication is used between the signal generator and the signal received. In another example embodiment of a mechanical system, mechanical links and pulleys are used for relaying steering input to the directional control mechanism 56.

In an example embodiment, the directional control mechanism 56 includes a motor configured to rotate a gear collar positioned on the conduit projection 22. In another example embodiment, when the user turns the handlebars, it will turn the rear air pipe in the opposite direction simultaneously. This redirects the direction of airflow coming out of the rear pipe, and thus steers the hovercraft. For instance, when the user turns the handlebars to the right, the rear air pipe turns to the left, which redirects the output airflow to the left and thus turns the hovercraft towards the right side. The rear pipe can be controlled wirelessly, electrical or mechanical methods.

In another example embodiment of steering, there may be blower or fan and an air rudder controls the direction that the air is moving. In another example embodiment, multiple propulsion nozzles may be positioned or angled in different ways from each other and the expelling of air or gas from one or more of the propulsion nozzles provides steering. It will be appreciated that other ways to change the direction that air is expelled may be used for steering the vehicle.

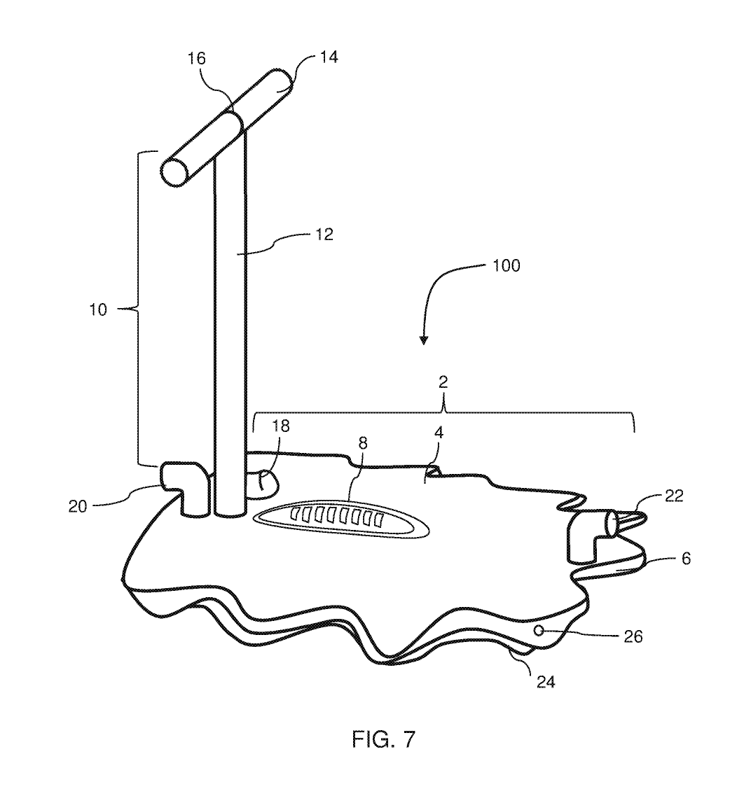

FIG. 7 shows an illustration of the example vehicle 100 in a deflated state. As shown in FIG. 7, the form or volume of the vehicle is substantially reduced due to the deflated main body 2 and the deflated skirt 24. Also evident in FIG. 7 however, are the seemingly rigid, or un-deflated, front facing conduit projection 20 and rear facing conduit projection 22. Though the various embodiments of the vehicle show that the projections 20 and 22 are consistently rigid despite the deflated state of the vehicle, it is possible to construct them using a flexible material, allowing them to collapse upon vehicle deflation and thus improve the smaller deflated form factor. In the example shown, the steering assembly 10 will remain rigid despite the vehicle's deflation. In an example embodiment, the deflated main body 2 and skirt 24 will fold automatically towards the blower 34 using mechanisms such as, but not limited to: a mechanical spring loaded system, a series of electrically actuated pivot joints, a resiliently deformable structure made of either a shape memory polymer (SMP), or a shape memory alloy (SMA), or a combination thereof. In another example embodiment the deflated main body 2 and skirt 24 will fold automatically towards the steering column 12 using similar mechanisms.

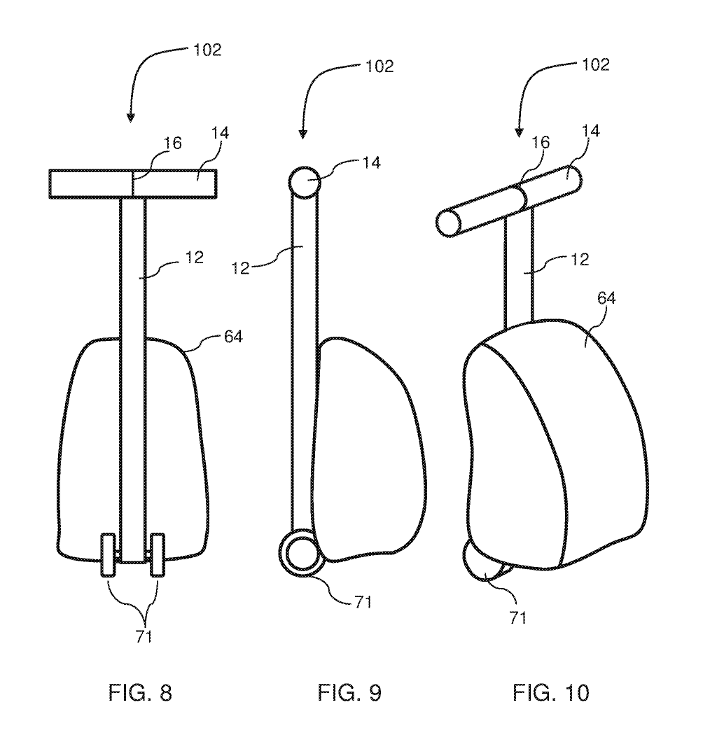

After the deflated main body 2 and skirt 24 of the vehicle have been folded towards the steering column 12, a cover bag 64 as shown in FIGS. 8-13 can be used to encase the folded components. FIGS. 8, 9 and 10 show the front, left and perspective views, respectively, of another embodiment of the inflatable vehicle incorporating an air cushion 102, but in a deflated and compact trolley bag form. In other words, the main body 2 and the skirt 24 are deflated and folded, and then are encased within a holder, such as a cover bag 64. The steering assembly 10 is used as the handle to support and tow the trolley bag. Other forms of holders may be used, including without limitation hard shell cases.

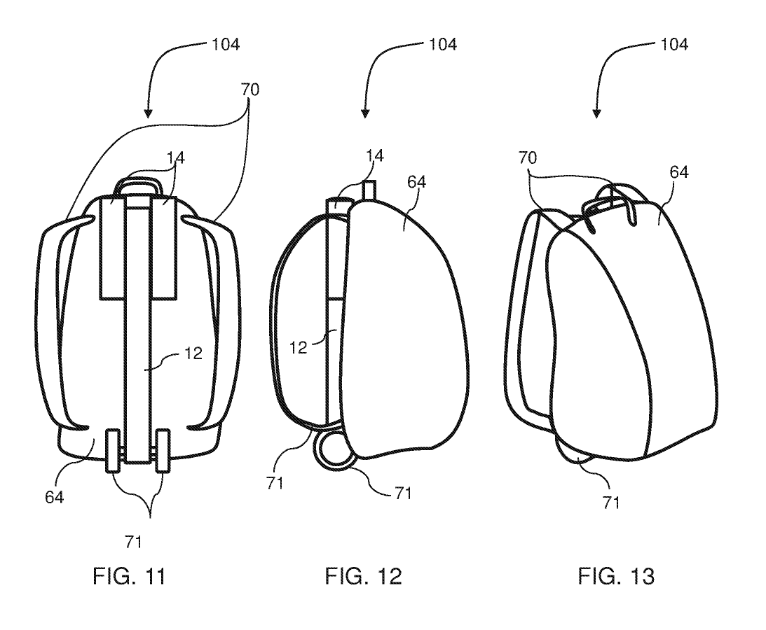

FIGS. 11, 12 and 13 show the front, side and perspective views, respectively, of another example embodiment of an inflatable vehicle incorporating an air cushion 104, but in a deflated and compact backpack form. In this embodiment 104, the main body 2 and the skirt 24 are deflated and folded, and then are encased within the cover bag 64. The steering column 12 is retracted and the handlebars 14 are folded at the hinge 16. The embodiment 104 includes and further utilizing a backpack strap 70 so that a user can carry the vehicle on their back.

Both embodiments 102 and 104 also include attachable wheels 71 that allow either embodiment to be wheeled along a surface. Preferably the cover bag 64 and the backpack straps 70 will fit within a provided pocket 18, represented in FIGS. 1, 2, 4, 5, 6 and 7. The pocket 18 may be removably attached to the main body 2, or may be positioned elsewhere.

Both the trolley bag embodiment 102 and the backpack embodiment 104 are non-limiting portable embodiments of the vehicle. The embodiments 102 and 104 serve to illustrate the ability of the vehicle to condense into a conveniently portable form factor, when deflated, that can be transported in any such appropriately sized container. Other form factors include other types of luggage.

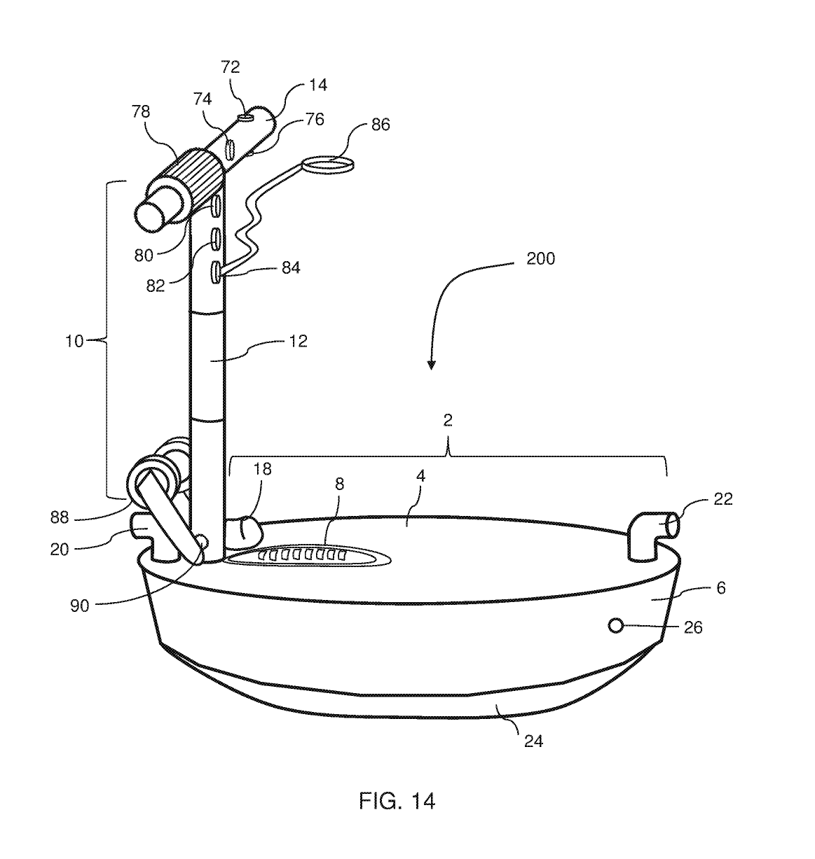

FIG. 14 shows a perspective view of another embodiment 200 of an inflatable vehicle incorporating an air cushion. As mentioned, the embodiments presented include the following elements: the inflatable main body 2; the inflatable flexible skirt 24; the front facing and rear facing conduit projections 20 and 22; the blower 34; the duct system 35; and the steering assembly 10. As shown in FIG. 14, the vehicle 200 is substantially similar to the example embodiment of the vehicle 100, with the exception of the user controls located on the steering assembly. In particular, on the handlebars 14, FIG. 14 shows a propulsion control 72, a “Cruise Control” control 74, a brake control 76 and an engine speed control 78. Furthermore, on the steering column 12, FIG. 14 shows an inflation control 80, a hovering control 82, a deflation control 84, a safety wristband 86 and fold-out trolley wheels 88. It can be appreciated that the positioning, shape and configurations of the controls and the safety wristband 86 may be different in other embodiments, but are still applicable to the principles described herein.

The user controls receive input from the operator to control various functions of the vehicle. The controls may include one or more of buttons, switches, handles, twistgrips, touch screens, pressure sensors, joysticks, and remote sensors. For example, the speed control 78 is shown as a twistgrip and twisting the twistgrip changes the force of the air from the propulsion nozzles or conduits. In another example, activation of the brake control 76 causes air to be directed to the forward or front facing conduit 20 to provide a propulsion force to cause the vehicle to go backwards or to slow down.

Although not pictured in the figures, the steering assembly 10 can also be configured to have other attachments. As non-limiting examples, these additional attachments can include displays for monitoring various performance indicators of the vehicle, sound systems, receivers for remote control or gesture control devices, or a combination thereof. The safety wristband 86 is preferably wired to the deflation control so as to deflate the vehicle in a scenario where the operator is involved in an accident or falls off the vehicle. In a non-limiting example, the fold-out trolley wheels 88 are attached to arms that extend from a wheel axle 90 being fixed within the steering column 12 yet providing rotational motion about an axis collinear with the length of the axle 90.

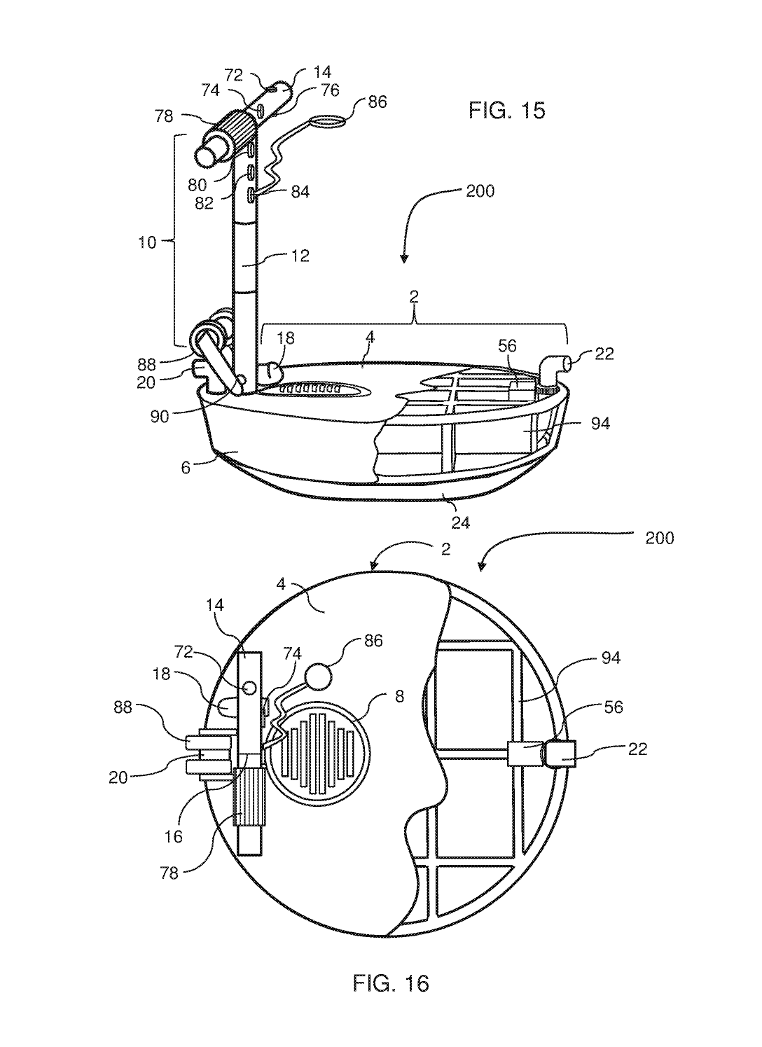

FIGS. 15 and 16 show another example configuration of a main body 2. In particular, an exterior surface of the main body 2 is partially cut-away to show inflatable ribs 94 within the main body 2. In this representation, the exterior of main body 2 remains visually the same as previous figures, although the internal structure of the main body is different. A network of ribs 94 defines a small cavity or network of cavities that can be inflated to provide a rigid structure to the main body. The space defined between the inflatable ribs 94 is not pressurized, or is at a pressure less than the pressure in the inflatable ribs 94 when the vehicle is in use. This is different than having an open cavity in the main body, as per FIG. 6 for example. It can be appreciated that the layout of the inflatable ribs 94 is an example, and other rib layout configurations may be used. Instead of having a singular large volume within the main body 2 to inflate, the inflatable ribs 94 could be used to provide the support for the operator and the other components, while significantly decreasing the inflation volume of the main body 2. This helps to decrease the time taken to inflate or deflate the main body 2.

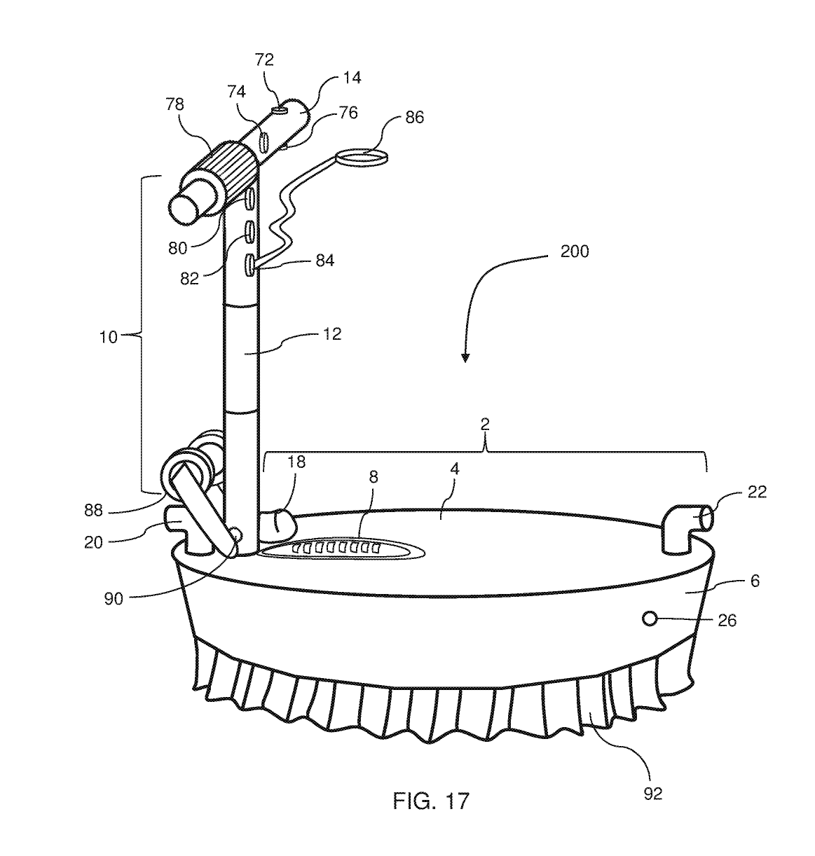

FIG. 17 shows a perspective view of another example of an inflatable vehicle incorporating an air cushion, which further includes a peripheral dust curtain 92 attached to the perimeter of the bottom of the main body 2. The curtain 92 aides in preventing debris from being scattered due to the flow of air from the air cushion 50, located under the center of the vehicle. The curtain 92 is preferably made of a durable yet flexible material. The curtain 92 may be made of a single continuous piece of material. In another example, the curtain 92 is made of several vertical strips depending from the perimeter of the bottom surface of the main body 2.

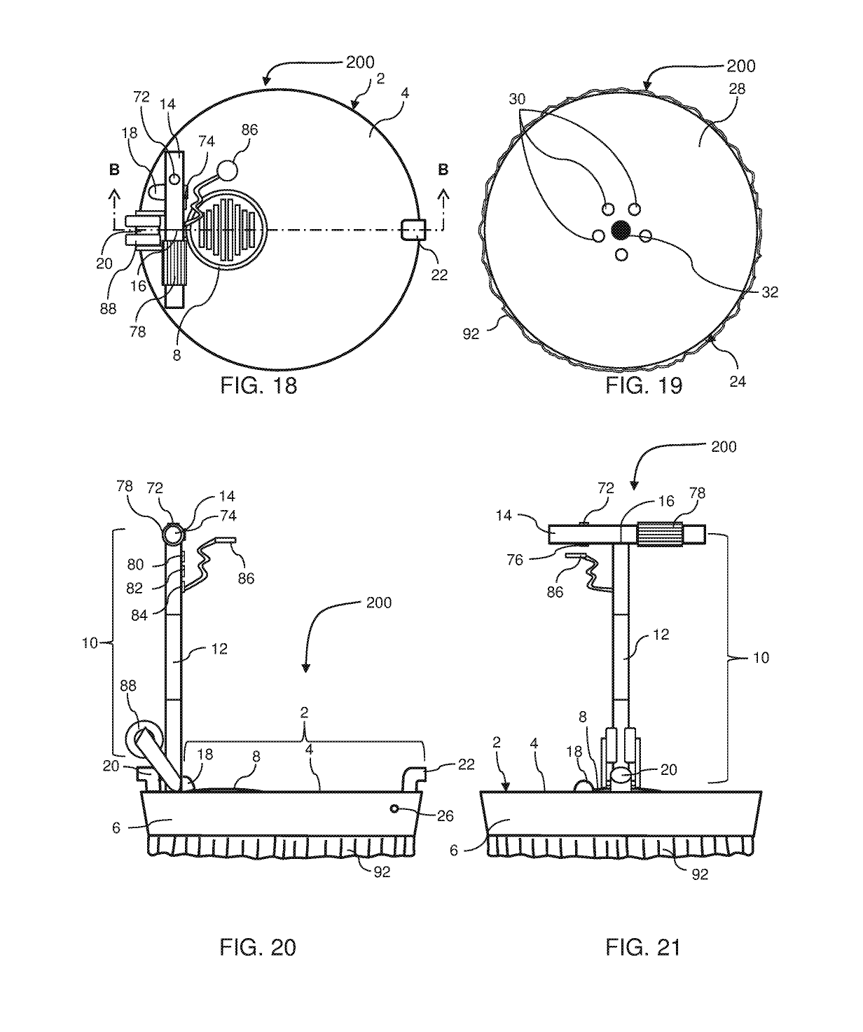

FIGS. 18, 19, 20 and 21 show orthographic views of the vehicle 200, which includes the curtain 92. As mentioned previously, it can be appreciated that the controls 72, 74, 76, 78, 80, 82, 84 and the safety wristband 86 are not limited to their positioning and layout as shown in figures.

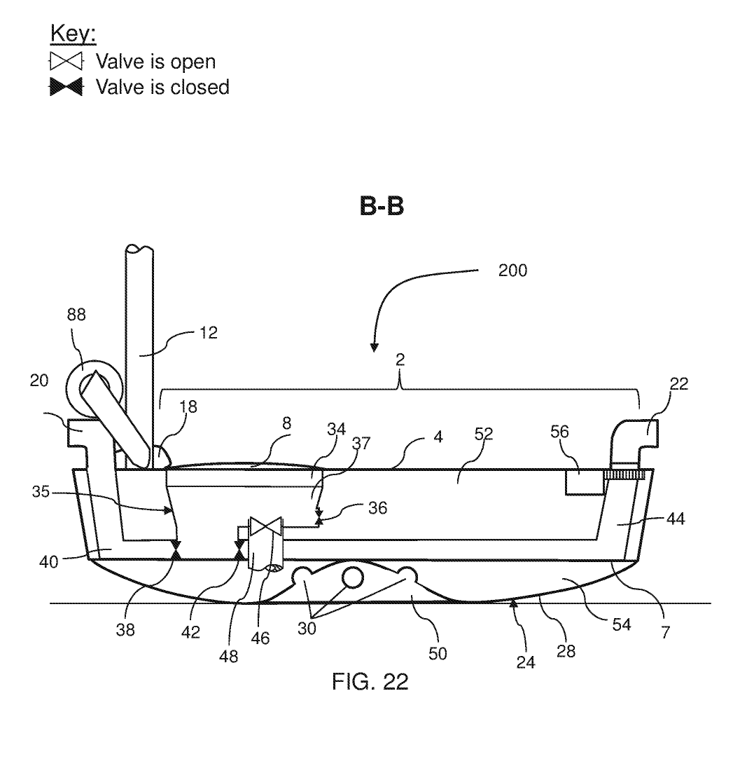

Turning to FIG. 22, a cross-sectional view is taken along line B-B in the top view in FIG. 18. Similar to FIG. 6, FIG. 22 illustrates how the blower 34 is in fluidic communication with the duct system 35 and, in particular, the main duct 37, the air cushion duct 48, the forward conduit 40 and the rear conduit 44. FIG. 22 thus also illustrates that the blower is in further fluidic communication with inflatable cavity of the main body 52 via the first valve 36, both the front facing conduit projection 20 and the rear facing conduit projection 22 via the second valve 38 and the third valve 42, respectively, and finally with the cavity of the skirt 54 via the air cushion duct 48 and the fourth valve 46.

Other configurations of duct systems and valves may be used, and may depend on various factors. These factors include, for example, the number of blowers, the number of valves, the type of valves, and the position and number of propulsion nozzles.

In the example of the inflatable ribs 94, the blower 34 is in fluidic communication with the cavity defined within the ribs. In this way, the main body 2 can be inflated to form a substantially rigid structure.

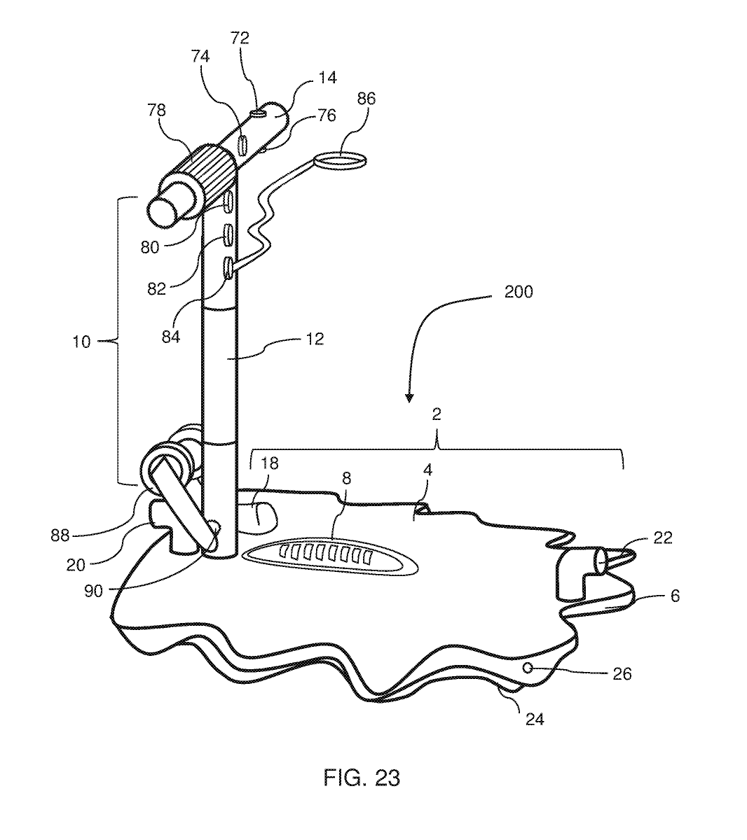

Turning to FIG. 23, the vehicle 200 is shown in the deflated state where the main body 2 and the skirt 24 have been deflated. As shown in FIG. 23, the height of the vehicle is substantially reduced due to the deflation of the main body 2 and the skirt 24. Also shown in FIG. 23 are the seemingly rigid, or un-deflated, front facing conduit projection 20 and rear facing conduit projection 22. Though the projections 20 and 22 are consistently shown in all embodiments as rigid, it is possible to construct them using a flexible material, allowing them to collapse upon vehicle deflation and thus adding to the decreased deflated form factor. The steering assembly 10 will remain rigid despite the vehicle's deflation. In an example embodiment, the deflated main body 2 and skirt 24 will fold automatically towards the blower 34 using mechanisms such as, but not limited to: a mechanical spring loaded system, a series of electrically actuated pivot joints, a resiliently deformable structure made of either a shape memory polymer (SMP) or a shape memory alloy (SMA), or a combination thereof. In another example embodiment the deflated main body 2 and skirt 24 will fold automatically towards the steering column 12 using similar mechanisms.

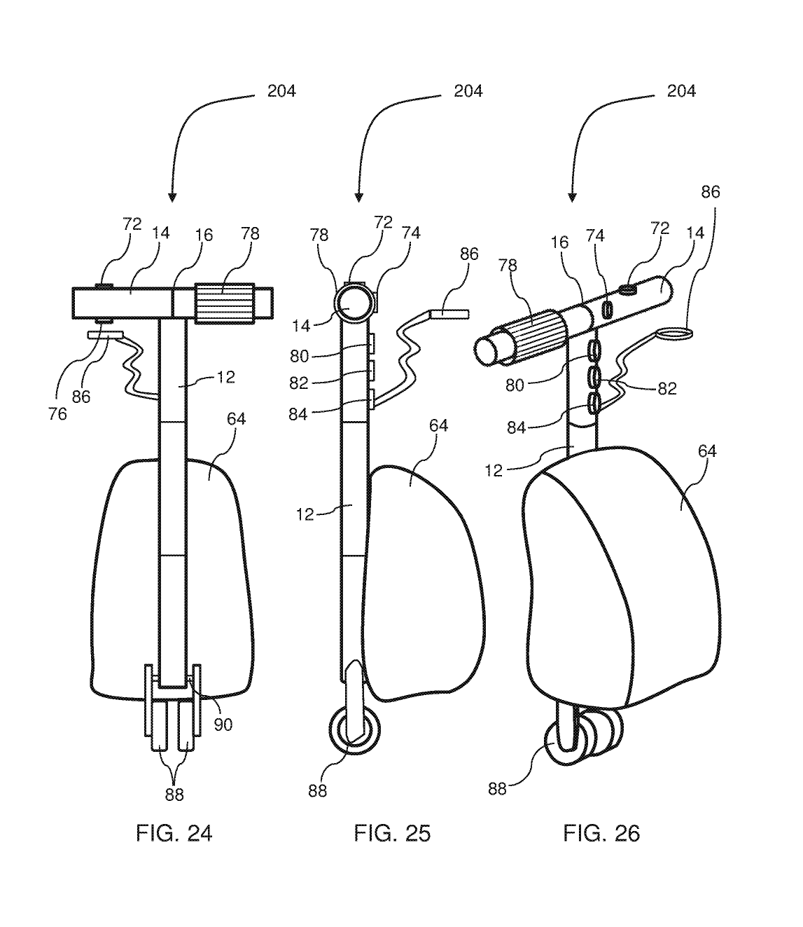

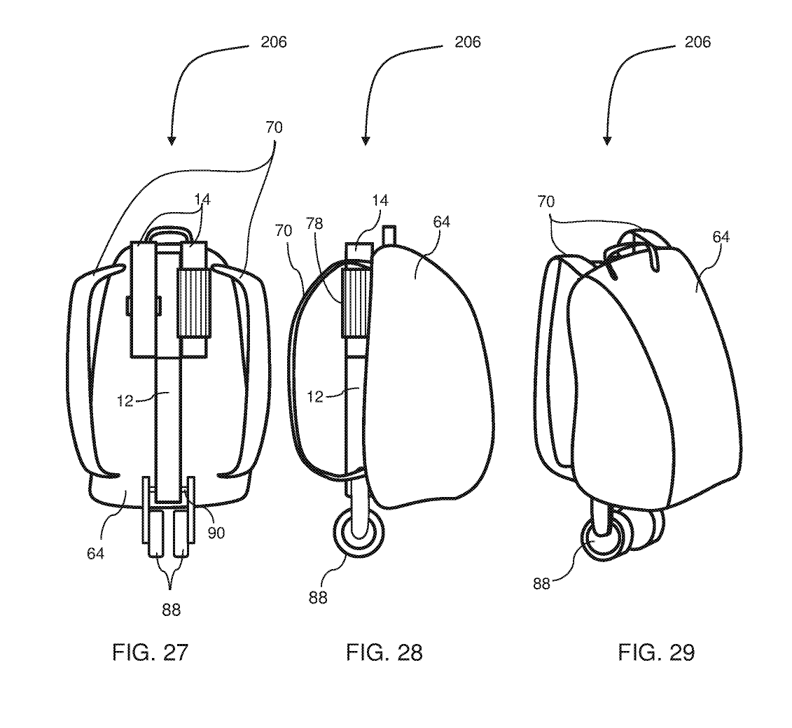

Once the deflated main body 2 and skirt 24 of the vehicle have been folded towards the steering column 12, the cover bag 64 as shown in FIGS. 24-29 can be used to encase the deflated folded components. FIGS. 24, 25 and 26 show the front, side and perspective views, respectively, of a vehicle transformed into a trolley bag 204. FIGS. 27, 28 and 29 show the front, side and perspective views, respectively, of a vehicle transformed into a backpack 205. In both embodiments 204 and 205 the fold-out trolley wheels 88 have been extended so as to provide support for wheeling either embodiment across a surface. Preferably, the cover bag 64 and the backpack straps 70 will fit within the provided pocket 18.

Both the second trolley bag embodiment 204 and the second backpack embodiment 205 are non-limiting portable embodiments of the vehicle. Similar to the embodiments 102 and 104, embodiments 204 and 205 serve to illustrate the ability of the vehicle to condense into a conveniently portable form factor, when deflated, that can be transported in any such appropriately sized container.

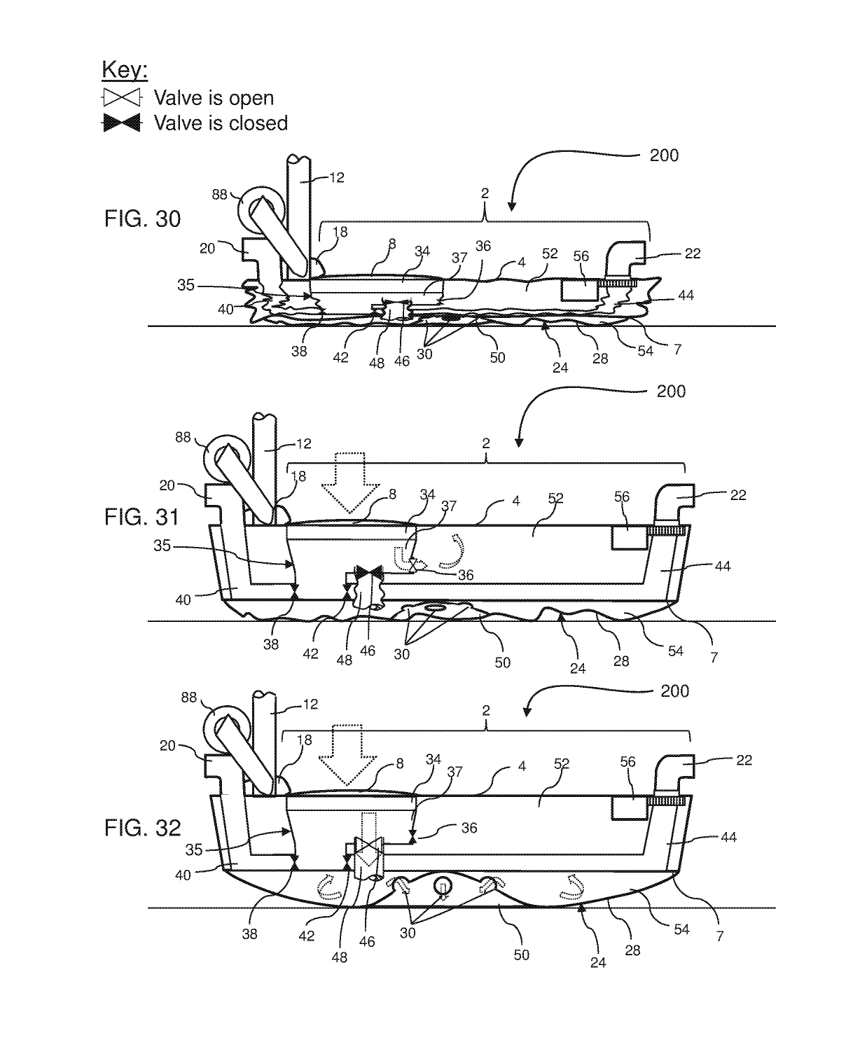

FIGS. 30-34 show cross-sectional views of an inflatable vehicle incorporating an air cushion, to depict the sequence of inflation and translation stages of the vehicle. In FIG. 30, the vehicle is in the state where the main body 2 and the skirt 24 are both deflated. It is apparent that the height and length of the vehicle in this initial deflated state, as shown in FIG. 30, are significantly shorter than when either the main body 2 or the skirt 24 are inflated. In FIG. 30 the seemingly rigid, or un-deflated, front facing conduit projection 20 and rear facing conduit projection 22 are also shown. Though the projections 20 and 22 are consistently shown in all embodiments as rigid, it is possible to construct them using a flexible material, allowing them to collapse upon vehicle deflation and thus adding to the vehicle's decreased deflated form factor. At least part of the duct system in FIG. 30 is formed from flexible or collapsible material, such as polymer sheets. This allows the duct system to deflate and be compact when not in use, and inflate when in use. The steering assembly 10, which includes the fold-out trolley wheels 88, will remain rigid despite the deflated state of the main body 2 and skirt 24.

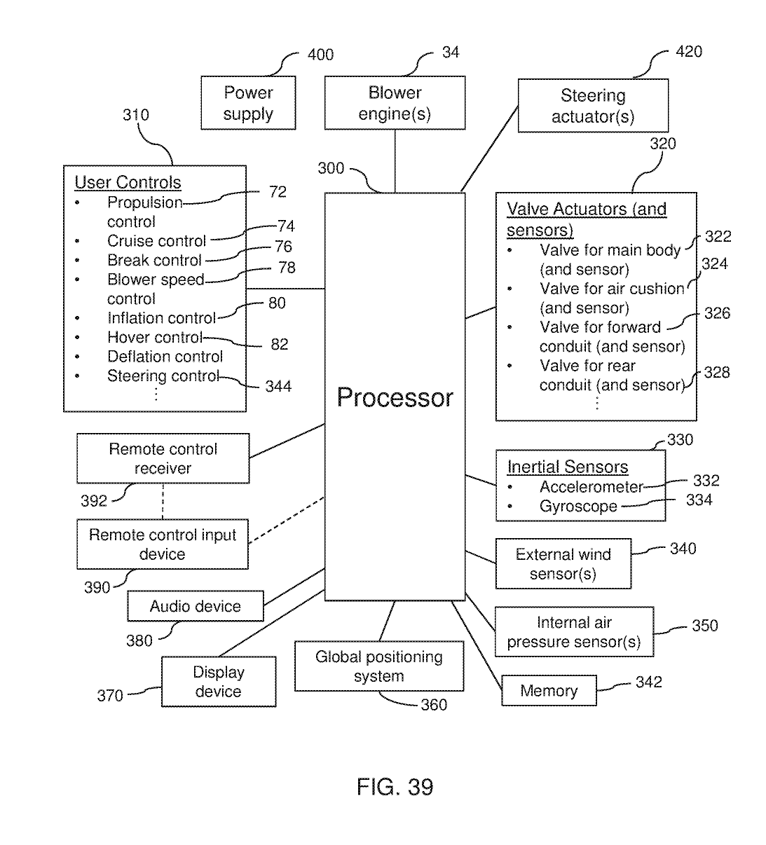

FIG. 31 depicts first inflation stage of the vehicle, which includes first inflating the main body 2. The first valve 36 is opened and air from the blower is pushed into the cavity within the main body 2. This inflation stage may be activated via the inflation control 80. During this inflation stage the second valve 38, the third valve 42 and the fourth valve 46 all remain closed, thus restricting air flow only to the inflatable cavity of the main body 52. This increases the speed at which the main body is inflated and helps to provide the necessary air pressure to form a substantially rigid main body. The flow of air in FIGS. 31, 32, 33 and 34 is represented by the dotted arrows. As shown in FIG. 31, ambient air from the surroundings is drawn in through the grill 8, after which the air is outputted into the main duct 37 and subsequently debouched or is discharged into the inflatable cavity of the main body 52. After an on-board processor 300 (see FIG. 39) detects that the inflatable cavity of the main body 52 has reached an appropriate pressure, the first valve 36 closes. Closing the valve 36 seals the cavity in the main body and maintains the high static air pressure in the main body. The appropriate pressure can be defined by the pressure at which the main body 2 is sufficiently rigid to allow an operator to stand thereon without the main body 2 deforming.

FIG. 32 depicts the next inflation stage of the vehicle after the main body is inflated. The fourth valve 46 is opened and the skirt 24 is inflated. This inflation stage will be activated via the hovering control 82, positioned on the steering assembly 10. During this inflation stage the first valve 36, the second valve 38 and the third valve 42 all remain closed, thus restricting air flow only to the cavity of the skirt 54 via the air cushion duct 48. This reduces the time to inflate the skirt and generate the air cushion. As shown in FIG. 32, ambient air of the surroundings is drawn in through the grill 8, outputted into the main duct 37 after which it enters the air cushion duct 48. As the cavity of the skirt 54 pressurizes, air egresses through the plurality of apertures of the skirt, located on the upwardly curved surface of the interior annulus of the skirt 24, thus pressurizing the air cushion volume 50. The air cushion volume 50 is defined by the surface of the interior annulus of the skirt 24, the centre portion 32 of the bottom surface of the main body 7, and the ground surface upon which the vehicle moves. By creating a volume of positive pressure underneath the vehicle, lift is achieved. When the hovering control 82 is activated the fourth valve 46 remains open leaving the vehicle in a “Hover” mode, until the deflation control 84 is activated.

More generally, the skirt forms a tubular structure that is continuous and defines an enclosed space when inflated. At least one of the apertures is positioned on an inner surface of the tubular structure. In an example embodiment, the shape of the enclosed space is a polygon, or circular. Other shapes are applicable to the vehicle. The space defined between the inner surface of the tubular structure and the ground surface is pressurized. As the pressurized air escapes this space between the ground surface the bottom of the skirt, the pressurized air forms a cushion of air that supports the vehicle.

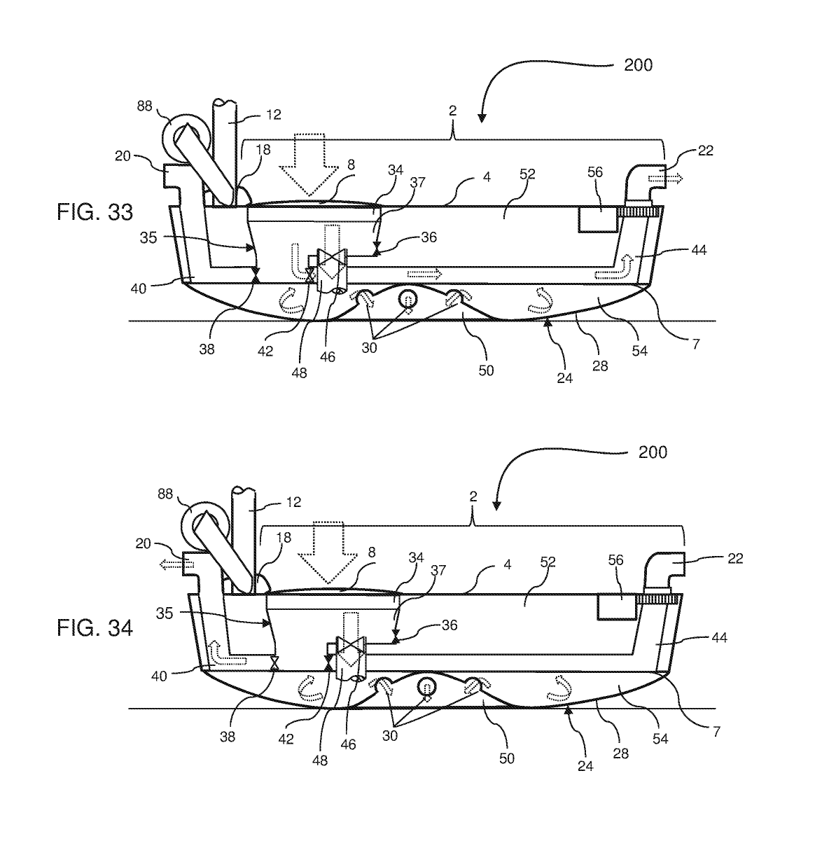

FIG. 33 depicts a translation state of the vehicle wherein the third valve 42 is opened via the activation of the propulsion control 72, positioned on the steering assembly 10. In this translation state, ambient air of the surroundings is drawn in through the grill 8, outputted under pressure into the main duct 37, and enters the rear conduit 44. From the conduit 44, the pressurized air is discharged through the rear facing conduit projection 22, providing a propulsive force to accelerate the vehicle in the opposite direction of the discharging air. In this state the first valve 36 and the second valve 38 remain closed while the third valve 42 and the fourth valve 46 remain open. Valve 46 remains open to maintain the air cushion effect. In an example embodiment, if the on-board processor 300 detects an absence of input to the propulsion control 72, the third valve 42 will close.

FIG. 34 depicts a second translation state of the vehicle wherein the second valve 38 is opened via the activation of the braking control 76, positioned on the steering assembly 10. Namely, in this translation state, ambient air of the surroundings is drawn in through the grill 8, outputted under pressure into the main duct 37, and then enters the front facing conduit 40. From the conduit 40, the pressurized air is discharged through the front facing conduit projection 20, providing a propulsive force to accelerate the vehicle in the opposite direction of the discharging air. In this state the first valve 36 and the third valve 42 remain closed while the second valve 38 and the fourth valve 46 remain open. In an example embodiment, if the on-board processor 300 detects an absence of input to the braking control 76, the second valve 38 will close. In an example embodiment, the second valve will close by default due to a biased mechanism (e.g. magnetic or spring bias).

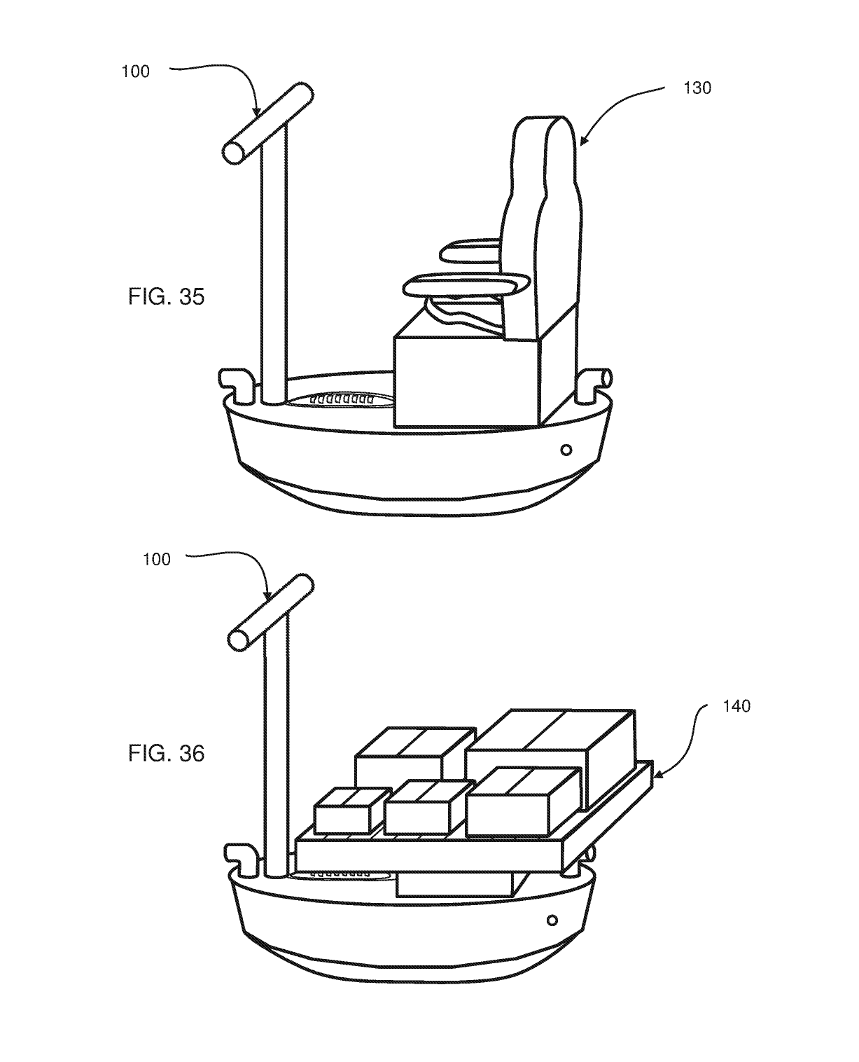

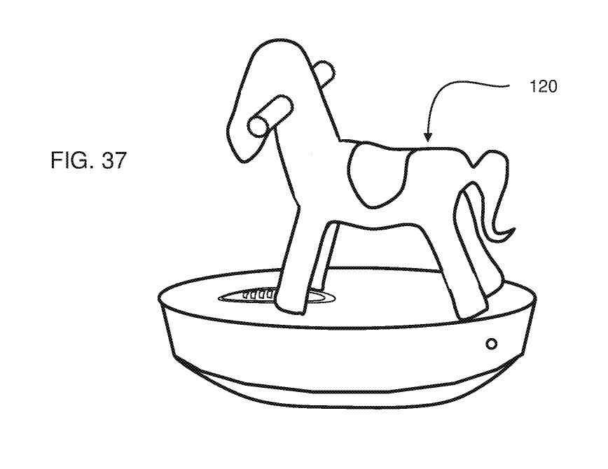

FIGS. 35 and 36 show the example embodiment of the vehicle 100 with various attachments. These attachments can be attached to the top surface of the main body 4 via attachment points positioned (not pictured) allowing for a multitude of applications for the inflatable vehicle. FIG. 35 shows a chair attachment 130 to be used for mobility assisted living for senior or disabled citizens. FIG. 36 shows a cart platform attachment 140 that allows the vehicle to be used as a cart to transport various goods and materials. In an example embodiment, the platform is a fork structure that holds a palette, and allows for a palette to be loaded and unloaded from the vehicle. With the cart platform attachment 140 it is apparent that the operator would not be standing on the main body 2 but instead will be pushing or pulling the vehicle. FIG. 37 shows yet another example embodiment of the vehicle 100 with a toy rocking horse attachment 120 for children. Although the steering assembly 10 is not pictured in FIG. 37, it can be understood that user controls for vehicle motion can be incorporated into the horse attachment 120. Furthermore, it will be appreciated that FIGS. 35, 36 and 37 represent non-limiting examples of the possible attachments and the corresponding applications which the vehicle can be used for. Other possible applications include, but are not limited to, military transport, disaster relief transport and camera supports for the film industry.

In another example embodiment, there are one or more auxiliary parts that are in fluidic communication with the duct system. An inflatable attachment may attach to an auxiliary part to receive pressurized air and become inflated a similar way the main body is inflated. The inflatable attachment may also be substantially rigid.

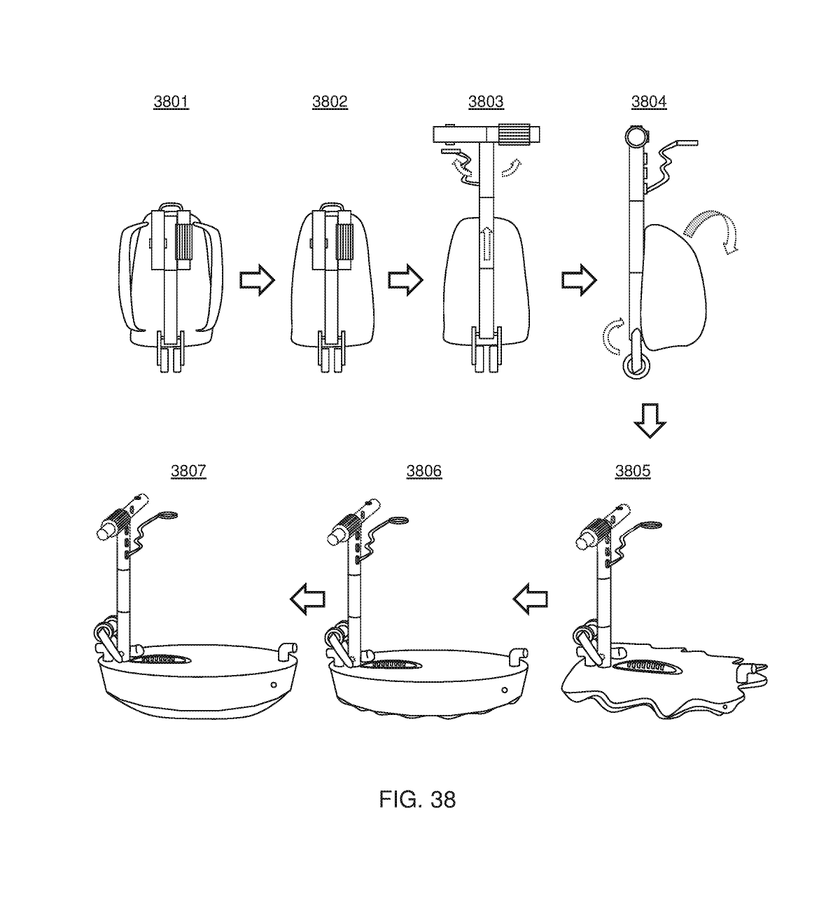

FIG. 38 shows the stages taken to transform an embodiment of the vehicle from a portable form to an operable form. Depicted first (3801) is a backpack embodiment of the vehicle from which the backpack straps 70 are removed or tucked away (3802). Next the steering column 12 is extended to its operating height and the handlebars 14 are folded upwards into their operating position (3803). The fold-out trolley wheels 88 are then folded upwards and the cover bag 64 encasing the deflated folded skirt 24, main body 2, and any other components situated thereon, is removed (3804). The folded deflated components are now unfolded outwards away from the steering column 12 (3805) and can thus be inflated (3806) to achieve an operable air cushion vehicle (3807).

FIG. 39 shows a schematic of the control system of the vehicle. The processor 300 is in electronic or data communication with various user controls 310, the remote control receiver 392 or remote control input device 390 (or both), the steering actuators 420, the valve actuators 320, and the blower 34. Furthermore, the processor 300 may also be in data communication with inertial sensors 330, external wind sensors 340, internal air pressure sensors 350 and a global positioning system 360. The internal pressure sensors detect the internal air pressure at one or more points within the vehicle, such as within the main body 2 and within the skirt 24. Real-time vehicle performance indicators and operation information may be presented to the user via a display 370 or an audio 380 devices, or both. A power supply 400 powers the components shown on FIG. 39. In an example embodiment, the remote control input device 390 detects gestures from a person to provide input to the control system.

The processor 300 executes instructions stored in memory 342 to control various operations of the vehicle. For example, based on the detected inputs from one or more of the controls 130, the processor activates or deactivates the blower 34 and opens or closes one or more of the valves 320. Each of the valves may include a sensor to provide feedback about the open or closed states of the valve. The valve actuators 322, 324, 326 and 328 correspond respectively to the valves 36, 46, 38 and 42.

If the steering system is electromechanical, for example drive-by-wire, the input from a steering control sensor 344 is detected and the processor uses the input to control one or more steering actuators 420, such as the directional control mechanism 56.

The other sensors 330, 340, 350 and 360 may obtain certain operational and environmental measurements. This data may be used by the processor to also vary the air output rate of the blower (e.g. cubic feet per minute) and to open or close valves. The GPS data may be displayed on the display device to help the user with navigation.

In an example embodiment, the gesture control is used to steer the vehicle, and to control other operations of the vehicle. An example type of gesture control is based on image tracking a body part of a user using a camera. Another type of gesture control is based on wearable technology that senses movement of a user (e.g. an arm) using inertial sensors or muscle electrical activity, or both. The wearable technology is an example of a gesture control input device 310.

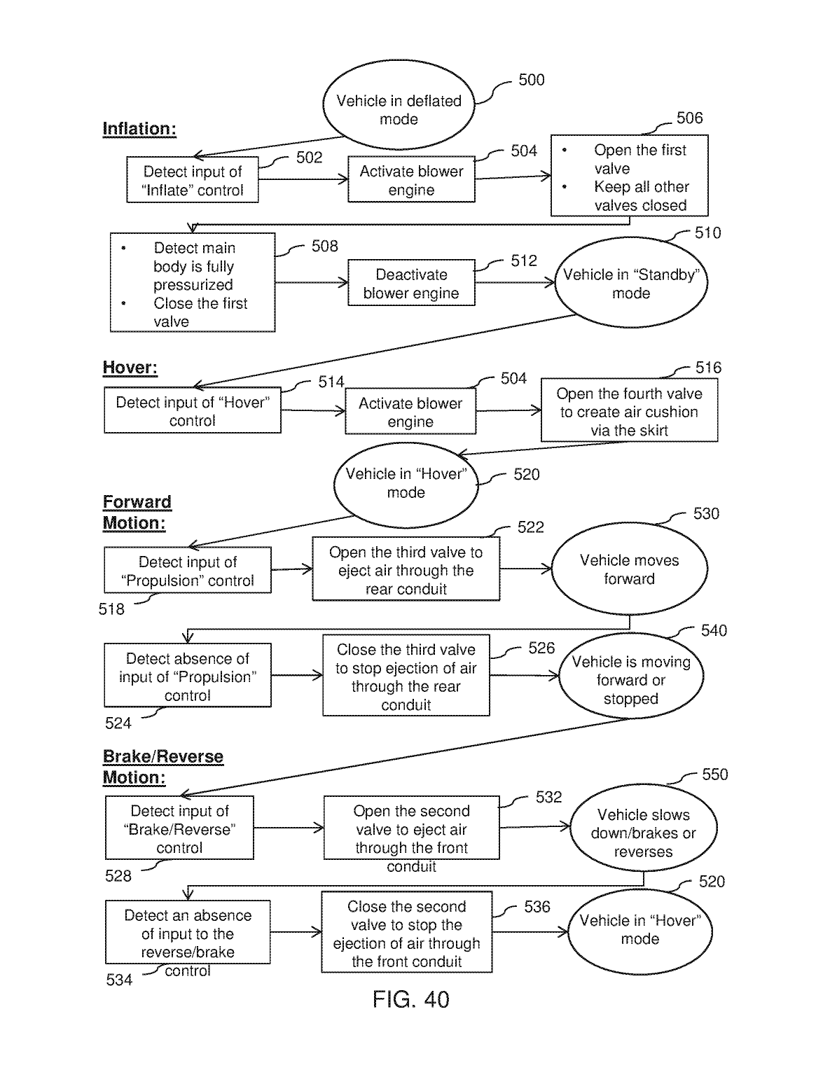

FIG. 40 is a flow chart that shows example executable instructions the processor 300 will execute during vehicle use. In particular, FIG. 40 shows the instructions processor 300 will follow for the scenarios of vehicle inflation, hovering, forward motion and braking/reverse motion. Beginning with the vehicle in state 500, the main body 2 and skirt 24 are deflated. The processor at block 502 detects the input of the “Inflate” control 80. The processor then activates the blower engine 34 at block 504. At block 506, the processor sends command to open the first valve 36 and keep all other valves closed, so as to inflate only the inflatable cavity of the main body 52. At block 508, after it is detected that the inflatable cavity of the main body 52 has been fully pressurized, the first valve 36 is closed. The blower engine deactivates in block 512 and the vehicle is now in a standby state 510. In particular, the main body is pressurized and is in a static state, and the air cushion is not activated. At this stage, the main body is a substantially rigid structure.

Continuing with FIG. 40, when the vehicle is in state 510, the processor detects input of the “Hover” control 82 at block 514. The processor activates the blower engine 34 at block 504. At block 516, the processor sends a command to open the fourth valve 46 to create the air cushion via the cavity of the skirt 54. The vehicle is subsequently in a hovering state 520.

Continuing from state 520, the processor detects input of the “Propulsion” control 72 at block 518. The processor sends a command to open the third valve 42 to eject air through the rear facing conduit projection 22, at block 522. The vehicle is then in a state of forward motion 530. If no input of the “Propulsion” control 72 is detected at block 524, the processor sends a command to close the third valve 42 (block 526) thus stopping air ejection through the rear facing conduit projection 22. The vehicle is then in state 540 wherein it is either moving forwards without being propelled forward or is stopped.

Continuing from state 540, if the input of the “Brake/Reverse” control 76 is detected, at block 528, the processor sends a command to open the second valve 38 to eject air through the front facing conduit projection 20, as per block 532. The vehicle is subsequently in state 550, wherein it is slowing down or reversing. If no input of the “Brake/Reverse” control 76 is detected (block 534), the processor sends a command to close the second valve 38 (block 538) to stop air ejection through the front facing conduit projection 20. The vehicle is then in state 520.

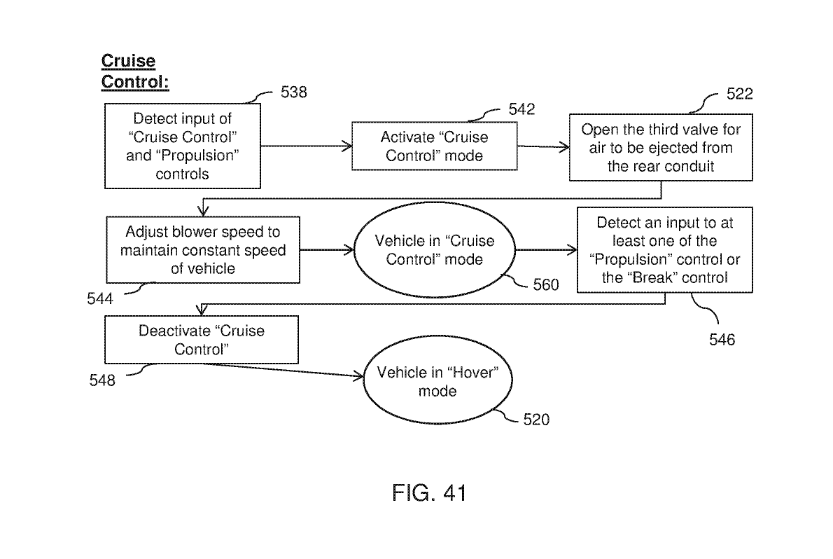

FIG. 41 is another flow chart showing example executable instructions for the processor 300 pertaining to the “Cruise Control” function. The vehicle uses cruise control to maintain a constant speed without any additional input from the operator. The speed of the vehicle may be detected from the measurements obtained from the wind sensor(s) 340, or the inertial sensors 330, or both. The detection of the inputs of both the “Cruise Control” control 74 and the “Propulsion” control 72, in block 538, activates a “Cruise Control” mode (block 542). At block 522, the processor sends a command to open the third valve 42 to eject air through the rear facing conduit projection 22. At block 544, the processor continually adjusts the blower speed to maintain a constant vehicle speed. The vehicle is then in state 560, or in “Cruise Control” mode. The detection of an input to either the “Propulsion” control 72 or the “Brake/Reverse” control 76, at block 546, deactivates “Cruise Control” (block 548). The vehicle then returns to state 520.

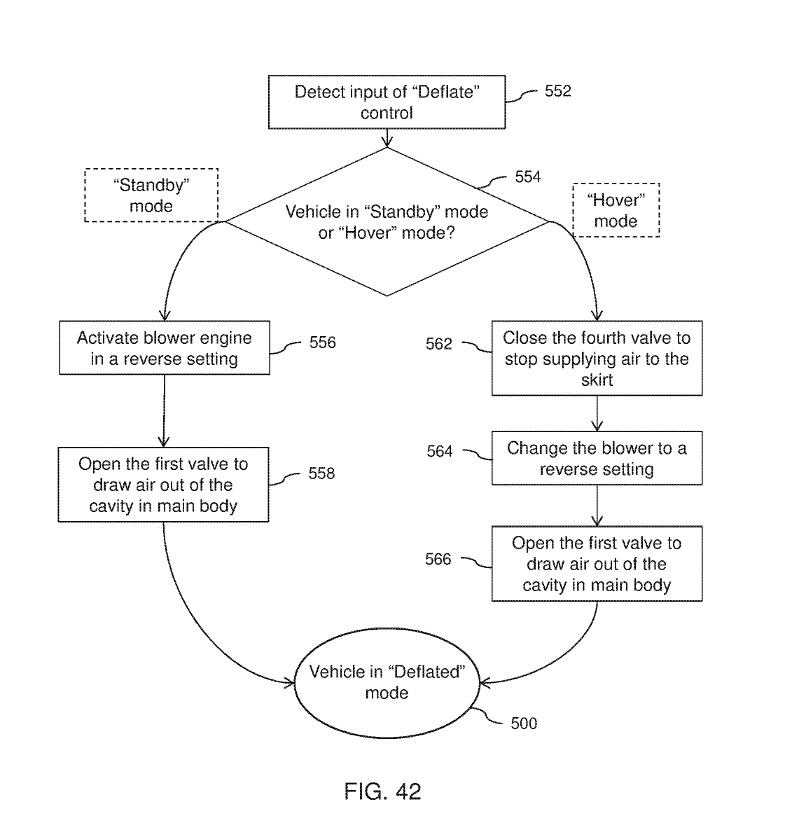

FIG. 42 is another flow chart showing executable instructions for the processor 300. In particular, FIG. 42 pertains to the deflation of the vehicle. When the input for the deflation control 84 has been detected, at block 552, the processor determines whether the vehicle is either in a “Standby” mode, wherein only the main body 2 is rigidly inflated, or in a “Hover” mode, wherein the main body 2 and the skirt 24 are inflated and the vehicle is hovering, as shown in decision diamond 554. If the vehicle is in “Standby” mode, the blower engine 34 is activated in a reverse setting (block 556) and the processor sends a command to open the first valve 36 to draw air out of the inflatable cavity of the main body 52 (block 558). The vehicle is then in a deflated state 500. If the vehicle is instead in “Hover” mode, the fourth valve 46 is first closed to stop air supply to the skirt (block 562). The blower engine 34 is then changed to a reverse setting (block 564), and the processor sends a command to open the first valve 36 to draw air out of the inflatable cavity of the main body 52 (block 566). The vehicle is then in the deflated state 500.

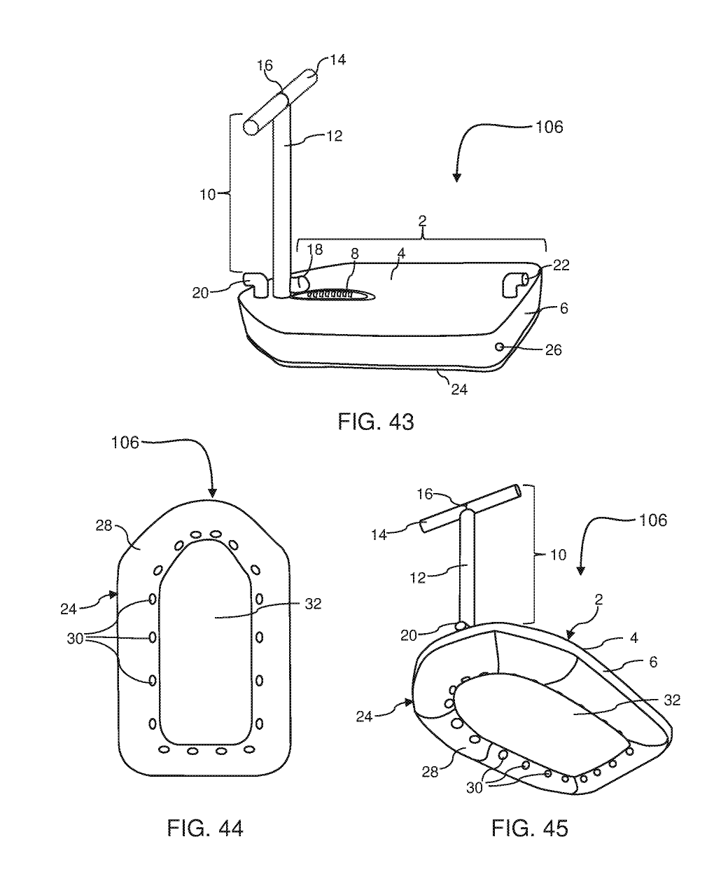

FIGS. 43, 44 and 45 show perspective, bottom and bottom perspective views of another embodiment 106 of an inflatable vehicle incorporating an air cushion. As mentioned, the embodiments presented include the following elements: the inflatable main body 2; the inflatable flexible skirt 24; the front facing and rear facing conduit projections 20 and 22; the blower 34; the duct system 35; and the steering assembly 10. As shown in FIG. 43, the vehicle 106 is substantially similar to the example embodiment of the vehicle 100, with the exception of the shape of the main body 2. As seen in FIG. 44, the main body 2 and consequently the skirt 24 of the vehicle 106 have a top view profile of a rounded rectangle with one side considerably rounded. Also shown in FIG. 44 is the plurality of apertures 30 positioned in a spaced manner in close vicinity to the center portion 32. FIG. 45 shows a bottom perspective view of the vehicle 106 and in particular illustrates the plurality of apertures 30 are positioned on an upwardly curved surface of the interior annulus of the skirt 24.

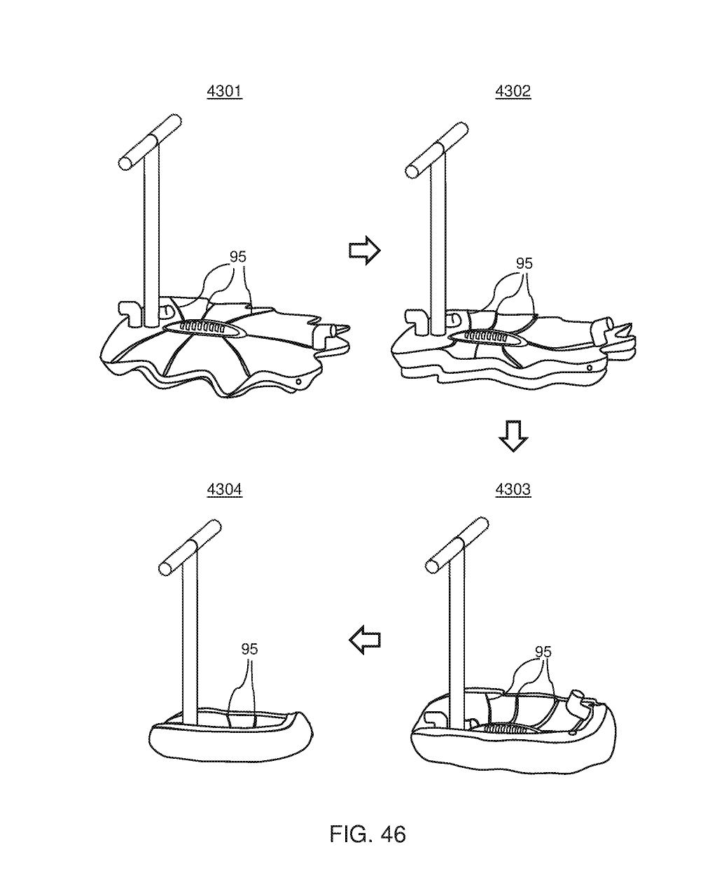

FIG. 46 shows the folding progression of an automatic folding mechanism incorporated into an embodiment of the vehicle 100 from an unfolded deflated state to a folded deflated state. In this example embodiment, the automatic folding mechanism is represented as folding flexible ribs 95 extending from the blower 34 towards the perimeter of the main body 2. Depicted first is the unfolded deflated state (4601), wherein the vehicle has successfully deflated after user operation. After this state is recognized, the flexible ribs 95 begin to curl upwards and inwards towards the blower 34 (4602 and 4603), consequently folding the main body 2 and the skirt 24. The flexible ribs 95 continue to curl until a sufficiently reduced form factor is achieved (4604) which will allow the vehicle to be encased within the cover bag 64. Preferably, the automatic folding mechanism will utilize mechanisms such as, but not limited to: a mechanical spring loaded system, a series of electrically actuated pivot joints, a resiliently deformable structure made of either a shape memory polymer (SMP) or a shape memory alloy (SMA), or a combination thereof.

In another example embodiment, the inflatable vehicle includes an automatic system that adjusts the height of the vehicle based on the terrain surface it is going over, to ensure that the vehicle is moving at a sufficient height about the surface. For example, the height of the skirt may be inflated more or less.

In another example embodiment, the inflatable vehicle also includes a warning system that indicates to the user to not go over a terrain if the hovercraft cannot achieve a certain hovering height to move safely over it.

In another example embodiment, the inflatable vehicle includes sensors as part of an obstacle detection system, which warns the user if the vehicle is too close to an obstacle or approaching an obstacle too quickly.

In another example embodiment, the propulsion control, brake control, and engine speed controllers operate in a continuous or variable manner, rather than in an on-and-off manner. For instance, pressing the brake button or control half way down opens a valve half way. In another example embodiment, the cruise control, inflate, deflate, and hover buttons operate in a discrete manner (e.g. on-and-off manner).

It will be appreciated that the features of the inflatable vehicle are described herein with respect to example embodiments. However, these features may be combined with different features and embodiments of the inflatable vehicle, although not explicitly stated.

While the basic principles of these inventions have been described and illustrated herein it will be appreciated by those skilled in the art that variations in the disclosed arrangements, both as to their features and details and the organization of such features and details, may be made without departing from the spirit and scope thereof. Accordingly, the embodiments described and illustrated should be considered only as illustrative of the principles of the inventions, and not construed in a limiting sense.

1. An inflatable vehicle incorporating an air cushion, the inflatable vehicle comprising:
a main body defining therein a cavity and configured to be inflated;
an inflatable, flexible skirt positioned below the main body, the skirt defining therein another cavity and comprising apertures to allow air to escape;
a blower that blows air, the blower supported by the main body when inflated; and
a duct system that is in fluidic communication with the blower, the cavity of the main body and the cavity of the skirt, and the duct system comprising valves to control the flow of air from the blower to first inflate the main body and subsequently inflate the skirt to form the air cushion.

2. The inflatable vehicle of claim 1 further comprising a propulsion system that ejects air to provide a propulsive force.

3. The inflatable vehicle of claim 2 wherein the propulsion system comprises a conduit supported by the main body when inflated, the conduit is fluidic communication with the blower via the duct system and configured to eject air to provide the propulsive force.

4. The inflatable vehicle of claim 3 wherein the conduit ejects air towards a rear of the inflatable vehicle.

5. The inflatable vehicle of claim 3 wherein the propulsion system further comprises a second conduit in fluidic communication with the blower and is positioned to eject air towards a front facing direction of the inflatable vehicle to provide another propulsive force.

6. The inflatable vehicle of claim 2 wherein the propulsion system comprises at least one other blower.

7. The inflatable vehicle of claim 1 further comprising a steering assembly comprising a steering column and handlebars, the steering assembly supported by the main body when inflated.

8. The inflatable vehicle of claim 7 wherein the steering column can be retracted to a smaller size.

9. The inflatable vehicle of claim 7 further comprising one or more wheels positioned adjacent to or on the steering column.

10. The inflatable vehicle of claim 9 configured to be deflated and stored into a holder attached to the steering column, and wherein the holder is transportable by pushing or pulling the steering column to roll the one or more wheels.

11. The inflatable vehicle of claim 10 wherein the holder is a bag.

12. The inflatable vehicle of claim 7 configured to be deflated and stored into a holder in a backpack form, the holder attached to the steering column that is in a retracted state.

13. The inflatable vehicle of claim 1 wherein the skirt is attached to a perimeter of the main body and is also attached to a center portion of a bottom surface of the main body.

14. The inflatable vehicle of claim 1 wherein the skirt is substantially torus-shaped when inflated.

15. The inflatable vehicle of claim 1 wherein at least a portion of the blower is positioned within the cavity of the main body.

16. The inflatable vehicle of claim 1 wherein the blower is configured to intake ambient air through a grill located on a top surface of the main body, and to output the ambient air under pressure into the duct system.

17. The inflatable vehicle of claim 1 wherein the valves comprise a valve to control the flow of air into the cavity of the main body and a valve to control the flow of air into the cavity of the skirt.

18. The inflatable vehicle of claim 1 further comprising a conduit in fluidic communication with the blower via the duct system and configured to eject air to provide a propulsion force, and the valves comprise a valve to control the flow of air into the cavity of the main body, a valve to control the flow of air into the cavity of the skirt, and a valve to control the flow of air into the conduit.

19. The inflatable vehicle of claim 1 wherein the skirt forms a tubular structure when inflated and at least one the apertures is positioned on an inner surface of the tubular structure.

20. The inflatable vehicle of claim 1 further comprising controls for vehicle inflation, vehicle speed and steering.

21. The inflatable vehicle of claim 15 wherein a remote control device is used to control one or more of the vehicle inflation, the vehicle speed and the steering.

22. The inflatable vehicle of claim 1 wherein a plurality of attachment points are provided on the top surface of the main body to facilitate the affixation of accessories to the vehicle.

23. A control system for an inflatable vehicle incorporating an air cushion, the control system comprising:
a blower in fluidic communication with a cavity defined by an inflatable main body and a cavity defined by an inflatable skirt positioned below the main body;
valves to control the flow of air between the blower and the cavity of the main body, and between the blower and the cavity of the skirt;
a processor that controls the blower and the valves; and
memory comprising instructions executable by the processor, the instructions comprising controlling the blower and the valves to first inflate the main body to form a substantially rigid structure that supports the blower and to subsequently inflate the skirt to form the air cushion.
